(19) United States
(12) Patent Application Publication
(10) Pub. No.: US 2002/0028648 A1
(43) Pub. Date: Mar. 7, 2002

(54) ENERGY-EFFICIENT FUME HOOD

(76) Inventor: BRUCE R. BIRCH, SAN DIEGO, CA (US)

Correspondence Address: PILLSBURY MADISON & SUTRO LLP, INTELLECTUAL PROPERTY GROUP, 1100 NEW YORK AVENUE NW, NINTH FLOOR EAST TOWER, WASHINGTON, DC, 200053918

(21) Appl. No.: 09/372,704

(22) Filed: Aug. 11, 1999

(51) Int. Cl. F24F 7/00; F24F 11/00; F23J 11/00; F24F 13/00; B08B 15/02; F24C 15/20

(52) U.S. Cl. 454/56

(57) ABSTRACT

An energy-efficient fume hood is provided having: (i) a housing with an access aperture to permit access to the interior of the fume hood; and (ii) a vertically movable frame attached to the housing about the access aperture. The vertical frame has two or more horizontally movable panels mounted therein. The horizontally movable panels may be used to close off substantially all or a portion of the access aperture, thereby reducing the volume of air required to be drawn through the access aperture in order to maintain desired face velocity, while permitting access to the interior of the fume hood. An exhaust system is used to draw fumes away from the interior of the fume hood. An air bypass is provided to permit airflow into the fume hood when the access aperture is closed.

### FIELD OF THE INVENTION

The present invention relates generally to fume hoods and, more specifically, to an energy-efficient fume hood comprising a vertically movable frame in which is disposed a plurality of horizontally movable panels.

### BACKGROUND OF THE INVENTION

An enclosed work cabinet having an exhaust system for the safe storage or manipulation of materials that emit undesirable and/or dangerous fumes is common in the laboratory environment. Such fume hoods are typically made up of a cabinet defining an interior working area and having an opening for providing a user access to the working area. In conventional fume hoods, the size of the access opening is usually varied by moving a single vertically movable access door or sash between its open and closed positions.

Ideally, the exhaust system of a fume hood is designed so that the face velocity of air entering the fume hood is maintained above a certain desired or requisite level, regardless of the position of the sash. Several prior art fume hood designs incorporate an air bypass located in the face of the cabinet above the access opening to the cabinet. The air bypass permits air to be drawn through the fume hood when the sash to the fume hood is in the closed position, thereby maintaining the face velocity of the fume hood at an essentially constant value. Other prior art fume hood designs incorporate a duct that draws auxiliary air into the hood from outside the laboratory environment; however, the auxiliary air often is of a different temperature and humidity than the air-conditioned laboratory air, sometimes leading to condensation and temperature control problems.

In addition, prior art fume hoods having a single sash design do not provide facile adjustment of the size of the fume hood access opening. Fume hood exhaust systems are typically designed to provide the requisite face velocity when the sash is fully opened, even though the sash may be in the open position only a small fraction of the operational time. Therefore, a significant amount of air-conditioned (i.e., heated or cooled) room air is needlessly discharged through the fume hood exhaust system.

### SUMMARY OF THE INVENTION

The present invention addresses many of the shortcomings of prior art fume hoods. In particular, according to one object of the present invention, a fume hood is provided that is energy-efficient, resulting in a substantial reduction in operating costs by reducing demands on the laboratory heating, ventilation and air-conditioning (HVAC) systems necessary to achieve the typical face velocity requirement of at least about 100 feet per minute (ft/min) across the opening of the fume hood.

According to another object of the present invention, a reduction is achieved in the volume of air required to be pumped by the fume hood exhaust system, while still maintaining the requisite face velocity through the user access aperture.

The foregoing objects are achieved by providing a vertically movable frame about the access aperture of the fume hood and by disposing within the vertical frame a plurality of horizontally movable panels which are positioned to close off a portion of the access aperture. Thus, only a portion of the access aperture (preferably, approximately the size of one horizontal panel) may be open at any one time, so that the proper air velocity can be maintained with a volume of airflow which is reduced in proportion to the portion that is closed (i.e., “covered” by the horizontal panels). The horizontally movable panels also permit access to any part of the fume hood since the panels can be moved to any of various desired positions.

According to one aspect of the present invention, a fume hood is provided comprising a housing which includes an exhaust port and a front face having an access aperture, wherein air is drawn from the housing and through the exhaust port. This fume hood also comprises a vertically movable frame disposed on the front face of the housing, wherein the vertical frame comprises two or more horizontally movable panels. The horizontally movable panels may be positioned by the user to “close” or “block off” selected portions of the access aperture.

In a preferred embodiment, the vertical frame has mounted therein either two or three horizontally movable panels. More preferably, each of the horizontally movable panels is approximately the same width. Accordingly, in certain preferred embodiments, the access aperture is “blocked off” by the horizontally movable panels by at least about 50% (in the case of two approximately equally-sized panels) or by at least about 67% (in the case of three approximately equally-sized panels). Preferably, the horizontally movable panels, when fully closed, “block off” substantially the entire access aperture.

Preferably, the vertical frame comprises one or more tracks in or on which the horizontal panels are movably mounted. Most preferably, the vertical frame comprises two tracks in which the horizontal panels are slidably mounted.

The horizontally movable panels are preferably transparent to allow viewing of the interior of the fume hood housing. Most preferably, the horizontal panels are made of glass or plastic.

The fume hood of the present invention preferably further comprises an air bypass, through which air is drawn when the access aperture is closed or substantially closed by the vertical frame and horizontal panels. More preferably, the air bypass is located in the bottom of the housing near the front face. Most preferably, the air bypass comprises a gap or slit located on the underside of the housing proximate to (e.g., directly behind) an airfoil at the lower front face of the fume hood.

Preferably also, an exhaust duct (e.g., a pipe or conduit) is operably attached to the exhaust port. Most preferably, the exhaust duct completely surrounds the exhaust port. In certain embodiments, the fume hood comprises an exhaust system adapted to draw (i.e., pull or blow) air from the fume hood housing into the exhaust duct. Preferably, the exhaust system is designed to provide a face velocity of at least about 100 ft/min, regardless of the position of the vertical frame or the positions of the horizontally movable panels.

In another aspect of the present invention, a fume hood is provided comprising a recess having an exhaust port and an access aperture, wherein air is drawn through the access aperture and into the exhaust port, and a vertically movable frame disposed about the access aperture, wherein the vertical frame comprises two or more horizontally movable panels.

In yet another aspect, the present invention provides a door adapted for use with a fume hood housing having an access aperture, the door comprising a vertically movable frame movably attached to the housing about the access aperture, wherein the vertical frame comprises two or more horizontally movable panels.

These and other aspects of the present invention will become apparent to one skilled in the art in light of the figures, the following description and the claims appended hereto.

### BRIEF DESCRIPTION OF THE FIGURES

The figures provided herein are illustrative of certain embodiments of the present invention and are not intended to be limiting in any manner. The scope of the invention is defined instead by the claims.

FIG. 1 is a perspective view of one embodiment of the present invention having three horizontally movable panels, illustrating both the vertically movable frame and the horizontally movable panels in their closed positions;

FIG. 2 is a perspective view of another embodiment of the present invention having two horizontally movable panels, illustrating both the vertically movable frame and the horizontally movable panels in their closed positions; and

FIG. 3 is a cross-sectional view of a lower portion of the vertical frame of FIG. 2, illustrating the horizontally movable panels (in a fully open position) mounted in or on two tracks within the vertical frame. FIG. 3a illustrates one embodiment in which the horizontal panels are mounted in two tracks. FIG. 3b illustrates another embodiment wherein the horizontal panels have wheels on their lower edges that engage or ride on two tracks.

### DETAILED DESCRIPTION OF THE PREFERRED EMBODIMENTS

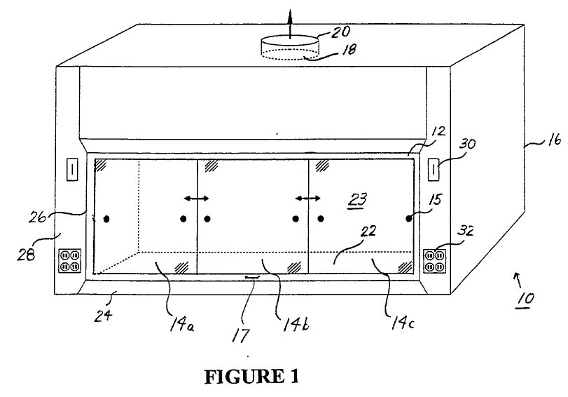

One embodiment of the fume hood of the present invention is shown in FIG. 1. Referring to FIG. 1, the fume hood of this embodiment is generally designated 10 and comprises a vertically movable frame 12, which has movably mounted therein three approximately equally-sized horizontally movable panels 14, designated 14a, 14b and 14c. Knobs 15 may be mounted on the horizontal panels 14 to facilitate movement by the user. A handle 17 may be provided to facilitate raising and lowering of the vertical frame 12 by the user.

The fume hood 10 also comprises a housing 16, which includes an exhaust port 18, to which is operably attached an exhaust duct 20. The housing 16 encloses a working surface 22 in the interior 23 of the fume hood and isolates the fume hood interior 23 from the surrounding environment.

Air is drawn by an exhaust system (not shown) at a particular face velocity through the access aperture 26 (essentially entirely “blocked” in FIG. 1 by the vertical frame and the horizontally movable panels 14) at the front face 28 of the housing 16. The air is then directed through the housing 16 and is exhausted through the exhaust port 18 into the exhaust duct 20. The exhaust system may be integrated into the fume hood of the present invention or may be separate therefrom, as in the case where the fume hood is attached to a portion of the HVAC system resident in the laboratory. Preferably, the exhaust duct 20 (e.g., a pipe or conduit) is operably attached to the exhaust port 18. Most preferably, the exhaust duct 20 completely surrounds the exhaust port 18.

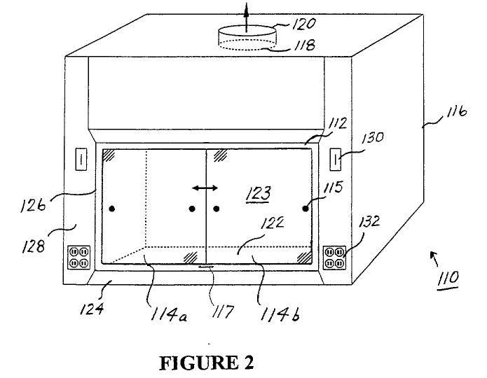

Another embodiment of the fume hood of the present invention is shown in FIG. 2, which is similar to the fume hood of FIG. 1, except for the number of horizontally movable panels. Referring to FIG. 2, the fume hood of this embodiment is generally designated 110 and comprises a vertically movable frame 112, which has movably mounted therein two approximately equally-sized horizontally movable panels 114, designated 114a and 114b. Knobs 115 may be mounted on the horizontal panels 114 to facilitate movement by the user. A handle 117 may be provided to facilitate raising and lowering of the vertical frame 112 by the user.

The fume hood 110 also comprises a housing 116, which includes an exhaust port 118, to which is operably attached an exhaust duct 120. The housing 116 encloses a working surface 122 in the interior 123 of the fume hood and isolates the fume hood interior 123 from the surrounding environment, which is generally designated 124.

Similarly to the embodiment in FIG. 1, air is drawn in FIG. 2 by an exhaust system (not shown) at a particular face velocity through the access aperture 126 (essentially entirely “blocked” in FIG. 2 by the horizontally movable panels 114) at the front face 128 of the housing 116. The air is then directed through the housing 116 and is exhausted through the exhaust port 118 into the exhaust duct 120. The exhaust system may be integrated into the fume hood of the present invention or may be separate therefrom, as in the case where the fume hood is attached to a portion of the HVAC system resident in the laboratory. Preferably, the exhaust duct 120 (e.g., a pipe or conduit) is operably attached to the exhaust port 118. Most preferably, the exhaust duct 120 completely surrounds the exhaust port 118.

The fume hood can be mated with an exhaust system adapted to draw (i.e., pull or blow) air from the housing into the exhaust duct. Preferably, the exhaust system is designed to provide a face velocity of at least about 100 ft/min, regardless of the position of the vertical frame or the positions of the horizontally movable panels. The exhaust system may, for example, include one or more blowers or fans capable of being driven at variable speeds to controllably increase or decrease the flow of air as the size of the access aperture is varied by movement of the horizontally movable panels.

For definitional purposes, the term “housing” is meant to encompass any structure or enclosure defining a working area amenable to the exhaust of fumes, including both free-standing enclosures (e.g., cabinets) and recesses in pre-existing structures such as walls.

The access aperture is varied in size by opening or closing the vertically movable frame, or by moving the horizontally movable panels mounted therein or thereon. The horizontally movable panels are positioned by the user to “close” or “block off” selected portions of the access aperture. In a preferred embodiment, the vertical frame comprises either two or three horizontally movable panels. More preferably, each of the horizontally movable panels is approximately the same width. Accordingly, in these preferred embodiments, the access aperture is “blocked off” by the horizontally movable panels by at least about 50% (in the case of two approximately equally-sized panels) or by at least about 67% (in the case of three approximately equally-sized panels). Preferably, the horizontally movable panels, when fully closed, “block off” substantially the entire access aperture. The horizontally movable panels can be moved to any horizontal position across the width of the access aperture to permit access to any part of the fume hood interior. Alternatively, the vertical frame may be raised to an extent that maintains the desired or requisite face velocity.

The horizontally movable panels are preferably made from a transparent material to permit viewing of the interior of the fume hood. Most preferably, the transparent material is plastic or glass.

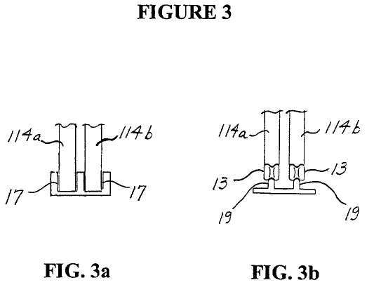

The horizontally movable panels may be mounted to or in the vertical frame according to any scheme within the knowledge or purview of one skilled in the art. Preferably, the horizontal panels are slidably mounted within the vertical frame. In one preferred embodiment, the vertical frame includes one or more tracks 17 in which the horizontal panels 114a and 114b are movably mounted (see FIG. 3a). In another preferred embodiment (illustrated in FIG. 3b), each of the horizontal panels 114a and 114b has one or more wheels 13 on at least the bottom edge of the panel, which wheels engage or ride on tracks 19 provided in the vertical frame. Wheels may also be provided at the top edge of the panels to facilitate sliding. In other embodiments, the horizontal panels are slidably mounted within the vertical frame using, for example, a tongue-and-groove arrangement or ball bearings. Most preferably, the vertical frame comprises two tracks in or on which the horizontal panels are slidably mounted.

An air bypass is preferably included in the fume hood of the present invention. The air bypass (not shown) comprises a bypass opening, preferably a slit or gap located between the bottom of the housing and the airfoil 24 or 124 in FIGS. 1 and 2, respectively. The airfoil 24 or 124 is preferably located proximate to the lower front edge of the access aperture. The air bypass permits air to be drawn through the fume hood without creating a substantial internal vacuum within the fume hood. The air bypass opening should be large enough to provide sufficient airflow into the fume hood. In a preferred embodiment, the air bypass comprises a gap about 1 cm to about 10 cm in width and extending substantially across the width of the fume hood. Some examples of prior art air bypasses are described in U.S. Pat. Nos. 4,023,473 and 4,142,458, the disclosures of which are incorporated herein by reference. The amount of air drawn through the air bypass is determined by the volume of air needed to maintain the requisite or desired face velocity. The horizontally movable panels of the present invention reduce the size of the access aperture, while permitting access to the interior of the fume hood. As a result, the horizontal panels permit the maintenance of the desired face velocity with a volume of air flow reduced approximately by the ratio of the width of the portion of the access aperture covered by the horizontally movable panels (at any given panel position) to the width of the access aperture in the fume hood housing (in the absence of horizontal panels). When both the vertical frame and the horizontal panels are in their closed positions (covering the access aperture), the air bypass and any gaps that may exist between the horizontal panels will permit sufficient air to be drawn into the fume hood without need for pressurizing the laboratory.

The fume hood may optionally have provisions for: lighting (see switches designated 30 and 130 in FIGS. 1 and 2, respectively); electrical outlets (see 32 and 132 in FIGS. 1 and 2, respectively); gas, air and water supplies; racks and shelves; sinks; waste disposals; hazardous or toxic waste collectors; and temperature and humidity control.

Other aspects of fume hood design and operation not specifically discussed herein are well known to those skilled in the art and are not essential to the description of the present invention. For example, U.S. Pat. Nos. 4,893,551 and 5,447,468, the disclosures of which are incorporated herein by reference, describe various conventional fume hood operational parameters and components which may be used in connection with the present invention.

In the foregoing description, specific preferred embodiments of the present invention have been illustrated and described. However, it is understood by those skilled in the art that certain modifications can be made to these embodiments and that equivalent structures or components may be substituted without departing from the spirit and scope of the invention.

What is claimed is:

1. A fume hood comprising:
a housing comprising an exhaust port and a front face having an access aperture, wherein air is drawn from the housing and through the exhaust port; and
a vertically movable frame disposed on the front face of the housing, wherein the vertical frame comprises two or more horizontally movable panels.

2. The fume hood of claim 1, wherein the vertical frame further comprises one or more tracks in which the two or more horizontally movable panels are movably mounted.

3. The fume hood of claim 1, wherein each of the two or more horizontally movable panels has approximately the same width.

4. The fume hood of claim 1, wherein the vertical frame comprises two horizontally movable panels.

5. The fume hood of claim 4, wherein each of the two horizontally movable panels has approximately the same width.

6. The fume hood of claim 1, wherein the vertical frame comprises three horizontally movable panels.

7. The fume hood of claim 6, wherein each of the three horizontally movable panels has approximately the same width.

8. The fume hood of claim 1, further comprising an exhaust duct operably attached to the exhaust port.

9. The fume hood of claim 8, further comprising an exhaust system adapted to draw air from the housing into the exhaust duct.

10. The fume hood of claim 9, wherein the exhaust system comprises one or more fans.

11. The fume hood of claim 1, further comprising an air bypass in the housing, the air bypass having a bypass opening to permit air to be drawn through the air bypass.

12. The fume hood of claim 11, further comprising an airfoil proximate to the lower front edge of the access aperture, wherein the bypass opening comprises a gap between the bottom of the housing and the airfoil.

13. The fume hood of claim 1, wherein the face velocity is at least about 100 ft/min.

14. The fume hood of claim 2, wherein the vertical frame has two tracks.

15. The fume hood of claim 13, having two horizontally movable panels, wherein each of the two panels is movably mounted within a separate track in the vertical frame.

16. The fume hood of claim 13, having three horizontally movable panels, wherein two of the panels are movably mounted in one track and the other panel is movably mounted in the other track.

17. The fume hood of claim 1, wherein at least one of the horizontal panels is transparent.

18. The fume hood of claim 1, wherein at least one of the horizontal panels is glass or plastic.

19. A fume hood comprising:
a recess having an exhaust port and an access aperture, wherein air is drawn through the access aperture and into the exhaust port; and
a vertically movable frame disposed about the access aperture, wherein the vertical frame comprises two or more horizontally movable panels.

20. A door adapted for use with a fume hood housing having an access aperture, the door comprising a vertically movable frame movably attached to the housing about the access aperture, wherein the vertical frame comprises two or more horizontally movable panels.
